(19) United States
(12) Patent Application Publication
(10) Pub. No.: US 2026/0270969 A1
(43) Pub. Date: Sep. 10, 2026

(54) METHODS FOR UPLINK AND DOWNLINK COLLISION HANDLING IN A NETWORK ENABLED WITH SUBBAND ADAPTATION

(71) Applicants: CENTRE OF EXCELLENCE IN WIRELESS TECHNOLOGY, Chennai, Tamil Nadu (IN); INDIAN INSTITUTE OF TECHNOLOGY MADRAS (IIT Madras), Tamil Nadu (IN)

(72) Inventors: Deepak Padmanabhan MAYAKUMARI, Chennai (IN); Priyanka DEY, Chennai (IN); Jeniston Deviraj Klutto MILLETH, Chennai (IN); Bhaskar RAMAMURTHI, Chennai (IN)

(21) Appl. No.: 19/167,447

(22) PCT Filed: Apr. 2, 2024
(86) PCT No.: PCT/IN2024/050352

§ 371 Date: Sep. 22, 2025

(30) Foreign Application Priority Data
Apr. 3, 2023 (IN) 202341025259

(51) Int. Cl. H04W 72/0453; H04L 5/00; H04L 5/14; H04W 74/0816

(52) U.S. Cl. CPC H04W 72/0453; H04L 5/0062; H04L 5/0094; H04L 5/14; H04W 74/0816

(57) ABSTRACT

A method of handling collisions in an SBFD operation includes receiving, by a first node, at least one parameter comprising configuration information of at least one subband for SBFD operation and scheduling information. The configuration information comprises at least one first time resource, at least one first frequency resource, and an identity of the at least one subband, and the scheduling information comprises at least one second time resource, at least one second frequency resource, a type of channel, and a type of signal. The first node determines an overlap between the at least one first time resource and the at least one second time resource, and the at least one first frequency resource and the at least one second frequency resource. The first node determines at least one third frequency resource and at least one third time resource based on the at least one parameter and the overlap.

### FIELD OF THE INVENTION

The present invention relates to collision handling in cellular networks, and more particularly to collision handling in networks enabled with subband adaptation.

### BACKGROUND OF THE INVENTION

In sub band full duplexing (SBFD) communication, a node can simultaneously perform downlink (DL) and uplink (UL) operations in different subbands within a same carrier frequency. The frequency resource within the same carrier frequency can be of fully overlapping, partially overlapping, or non-overlapping subbands. FIG. 1 cumulatively illustrates different types of SBFD subbands. FIG. 1a illustrates non-overlapping subbands, FIG. 1b illustrates partially overlapping subbands, and FIG. 1c illustrates fully overlapping subbands.

One major drawback of SBFD operation is self-interference (SI) caused by simultaneous DL and UL transmission and reception, respectively in a node. In case of SBFD with non-overlapping subbands, guard bands can be used between the frequency resources for DL and UL operation to minimize the impact of SI.

In fifth generation new radio (5G-NR) specification, a carrier can be configured for either DL or UL operations at a time. In SBFD, subbands can be configured within the carrier and subbands can be simultaneously configured for different set of operations (E.g., DL and UL). Below explained scenarios may arise within a carrier due to frequency domain configuration for SBFD.

In one scenario i.e. DUD scenario, UL subband may exist within same carrier configured for DL for a time resource. In this scenario, the UL subband is sandwiched between two DL subbands. For example, carrier is configured for DL operation in a time resource using the techniques defined in 5G-NR. Simultaneous UL operation can be enabled within the same carrier by configuring a UL subband, for UL operation, and activating it in the time resource. In another example, the base station (gNB) can configure a UL subband within the same carrier, configured for DL operation using methods defined in 5G-NR, and can schedule UL transmission from user equipment (UE) in the configured UL subband. Therefore, the gNB will simultaneously perform DL transmission to a UE in the DL subband and UL reception from another UE in the UL subband within the same carrier.

In another scenario i.e. UDU scenario, the DL subband may exist within the same carrier configured for UL for a time resource. In this scenario, the DL subband is sandwiched between two UL subbands. For example, the carrier is configured for UL operation in a time resource using one of the methods defined in 5G-NR specification. Now, the simultaneous DL operation can be enabled within the same carrier by configuring a DL subband, for DL operation, and activating it in the time resource. In another example, the gNB can configure a DL subband within the same carrier, configured for UL operation using one of the methods defined in 5G-NR specification, and can schedule DL transmission to a UE in the configured DL subband. Therefore, the gNB can simultaneously perform UL reception in the UL subband and DL transmission to another UE in DL subband.

Further, the SBFD operation can be enabled for a set of time resources, referred as SBFD active time resources in this document, in which the subband is active. The SBFD active time resource can be contiguous or discontiguous. The time resource granularity can be at symbol level, at slot level or resource type within a slot. FIG. 2 illustrates a notion of UL subband and SBFD active time resource, in accordance with an embodiment of the present invention. A resource grid consisting of 8 resource blocks (RBs) and 7 symbols within a carrier is shown. The carrier is configured to perform DL operation using conventional methods. In SBFD, the portion from RB1 to RB4 can be configured as UL subband and UL operation can be configured within the subband. It can be seen that the UL subband is active only from symbols 1 to symbol 5 and is denoted as SBFD active time resources.

A node enabling SBFD can create conflicts to other nodes in the network. Also, it can create variations in the resources or parameters associated with the DL/UL operations configured to other nodes in the network. For example, a UE can be configured with a set of frequency resources as DL bandwidth part (BWP). The gNB schedules DL operations to the UE only in the frequency resources within DL BWP. The gNB can schedule the UE to receive channel state information reference signal (CSI-RS) and measure channel parameters. CSI-RS is a wide band signal that span across the whole DL BWP of the UE. If UL subband overlaps with the DL BWP configured to the UE, then the gNB can perform either UL operation using the resources within the DL BWP of the UE. In that case, the UE cannot expect CSI-RS reception within the portion of DL BWP overlapping with UL subband. The scenario is depicted in FIG. 3 illustrating conflict among SBFD operation and conventional configurations. In FIG. 3, resources from RB3 to RB5 denote the DL BWP configured to the UE and RB1 to RB4 denote the UL subband for SBFD operation. Therefore, the RB3 and RB4 are common for DL BWP and UL subband. In case of SBFD with non-overlapping subbands, either DL or UL can be performed in RB3 and RB4. Similarly, in case of SBFD with overlapping subbands, the interference conditions will be different in RB3-RB4 and RB5. Further, these limitations/issues will be valid for RB3 and RB4 only in symbols 3-5, where subband is active and SBFD operation is performed.

The node can indicate parameters of SBFD operation, such as subband and SBFD active time resources, to other nodes in the network, so that the nodes can adapt the operations according to the parameters of SBFD operation. However, the adaptation depends on various factors like the type of indication of parameters, the type of conflict, importance of the configurations/signals creating the conflict, etc.

In SBFD, a portion of carrier is divided into subbands and a different set of operations can be configured within each subband. Therefore, SBFD can create conflicts among various signals/channels configured by conventional methods i.e. methods defined in 5G-NR. If BWP of a UE is overlapping with the subband for SBFD operation, then SBFD operation can create conflicts with signals configured for the UE in the overlapping portion. FIG. 4 illustrates a few examples of collision occurring in SBFD scenario. As shown in FIG. 4, DL data channel (physical downlink shared channel i.e. PDSCH) is scheduled to a UE in resource set 1 (i.e., symbols 1-3 and RB2-RB3), which is completely overlapping with the UL subband (RB1-RB4) and SBFD active time resources (symbols 1-5). In case of non-overlapping SBFD, the gNB cannot perform transmission of PDSCH and UL operation in the same frequency resources, resulting in collision. FIG. 4 also illustrates examples of partial overlap between DL and UL operations. PDSCH2 is scheduled in RB3 to RB6 of symbol 5, of which RB3 and RB4 are configured for SBFD operation. Similarly, PDSCH3 is scheduled in RB1 from symbol 4 to symbol 6, of which symbol 4 and symbol 5 are SBFD active time resources. Therefore, collision handling is essential in case of SBFD.

Therefore, there arises a need of a method of uplink and downlink collision handling in a network enabled with subband adaptation.

### OBJECTS OF THE INVENTION

A general objective of the present invention is to perform collision handling in a network.

Another objective of the invention is to perform collision handling in case of high priority signals.

Yet another objective of the invention is to perform collision handling based on scheduling mechanism.

### SUMMARY OF THE INVENTION

The summary is provided to introduce aspects related to a method for uplink and downlink collision handling in a network enabled with subband adaptation, and the aspects are further described below in the detailed description. This summary is not intended to identify essential features of the claimed subject matter nor is it intended for use in determining or limiting the scope of the claimed subject matter.

In one embodiment, a method of handling collisions in a Sub Band Full Duplexing (SBFD) operation in a cellular network is described. The method comprises receiving, by at least one first node, at least one parameter from at least one second node, wherein the at least one parameter comprises at least one of configuration information of at least one subband for SBFD operation and scheduling information. The configuration information comprises at least one first time resource, at least one first frequency resource and an identity of the at least one subband. The at least one subband is active in the at least one first time resource and the at least one first frequency resource. The scheduling information comprises at least one second time resource, at least one second frequency resource, and one of a type of channel and a type of signal. The method further comprises determining, by the at least one first node, an overlap between the at least one first time resource and the at least one second time resource, and the at least one first frequency resource and the at least one second frequency resource. The method further comprises determining, by the at least one first node, at least one third frequency resource and at least one third time resource based on the at least one parameter and the overlap. The method further comprises performing, one of transmission, reception and blanking in the at least one third frequency resource and the at least one third time resource.

In one aspect, the type of signal is one of a DL signal and a UL signal.

In one aspect, the type of channel is one of a DL channel and a UL channel.

In one aspect, the type of channel is one of a broadcast channel, a control channel, and a data channel.

In one aspect, the type of signal is one of a reference signal and a synchronization signal.

In one aspect, when the identity of the at least one subband is same as one of the type of channel and the type of signal,
the at least one third frequency resource is an overlapping frequency resource of the at least one first frequency resource and the at least one second frequency resource, and
the at least one third time resource is an overlapping time resource of the at least one first time resource and the at least one second time resource.

In one aspect, when the identity of the at least one subband is different from one of the type of channel and the type of signal,
the at least one third frequency resource is the at least one second frequency resource, and
the at least one third time resource is the at least one second time resource.

In one aspect, when the identity of the at least one subband is different from one of the type of channel and the type of signal,
the at least one third frequency resource is a non-overlapping frequency resource of the at least one first frequency resource and the at least one second frequency resource, and
the at least one third time resource is a non-overlapping time resource of the at least one first time resource and the at least one second time resource.

In one aspect, the method comprises determining a time gap between receiving configuration information of at least one subband for SBFD operation and scheduling information is less than a threshold.

In one aspect, the threshold is one of
a predefined value,
a value indicated by the at least one second node using at least one of RRC message, MAC-CE and DCI, and
a preparation time of at least one uplink signal.

In one aspect, when one of the type of channel and the type of signal is high priority,
the at least one third frequency resource is the at least one second frequency resource, and
the at least one third time resource is the at least one second time resource.

In one aspect, the high priority is one of
when the type of signal is a synchronization signal,
when the type of channel is one of broadcast channel, control channel, random access channel and a data channel comprising at least one system information, and
indicated by at least one second node in scheduling information.

In one aspect, performing the blanking includes one of:
performing no transmission in the at least one third frequency resource and the at least one third time resource; and
performing no transmission in selected resources of the at least one third frequency resource and the at least one third time resource,
wherein the selected resources are indicated using a rate matching pattern from the at least one second node.

In one aspect, one of the type of channel and the type of signal comprises at least one of:
reception of one or more of Physical Downlink Control Channel (PDCCH), Physical Downlink Shared Channel (PDSCH), and Channel Status Information-Reference Signal (CSI-RS); and
transmission of one or more of Physical Uplink Control Channel (PUCCH), Physical Uplink Shared Channel (PUSCH), Physical Random Access Channel (PRACH), and Sounding Reference Signal (SRS).

In one aspect, the method comprises transmitting at least one feedback by the at least one first node.

In one aspect, the feedback is for one of transmission and reception in the at least one third frequency resource and the at least one third time resource.

In one aspect, the feedback is for one of
an overlapping portion of the at least one first time resource and the at least one second time resource and an overlapping portion of the at least one first frequency resource and the at least one second frequency resource, and
at least one second time resource not overlapping with at least one first time resource and at least one second frequency resource not overlapping with at least one first frequency resource.

In one aspect, determining the at least one third frequency resource and the at least one third time resource comprises:
determining whether the scheduling information is one of semi-static and dynamic; and
determining whether the configuration information is one of semi-static and dynamic.

In one embodiment, a method of handling collisions in a Sub Band Full Duplexing (SBFD) operation in a cellular network is described. The method comprises transmitting, by at least one second node, at least one parameter to at least one first node, wherein the at least one parameter comprises at least one of configuration information of at least one subband for SBFD operation and scheduling information. The configuration information comprises at least one first time resource, at least one first frequency resource and an identity of the at least one subband. The at least one subband is active in the at least one first time resource and the at least one first frequency resource. The scheduling information comprises at least one second time resource, at least one second frequency resource, and one of a type of channel and a type of signal. Transmission of the at least one parameter allows the at least one first node to determine an overlap between the at least one first time resource and the at least one second time resource, and the at least one first frequency resource and the at least one second frequency resource. The method further comprises determining at least one third frequency resource and at least one third time resource based on the at least one parameter and the overlap.

In one aspect, the type of signal is one of a DL signal and a UL signal.

In one aspect, the type of channel is one of DL channel and UL channel.

In one aspect, the type of channel is at least one of a broadcast channel, a control channel, and a data channel.

In one aspect, the type of signal is one of a reference signal and a synchronization signal.

In one aspect, when the identity of the at least one subband is same as one of the type of channel and the type of signal,
the at least one third frequency resource is an overlapping frequency resource of the at least one first frequency resource and the at least one second frequency resource, and
the at least one third time resource is an overlapping time resource of the at least one first time resource and the at least one second time resource.

In one aspect, when the identity of the at least one subband is different from one of the type of channel and the type of signal,
the at least one third frequency resource is the at least one second frequency resource, and
the at least one third time resource is the at least one second time resource.

In one aspect, when the identity of the at least one subband is different from one of the type of channel and the type of signal,
the at least one third frequency resource is a non-overlapping frequency resource of the at least one first frequency resource and the at least one second frequency resource, and
the at least one third time resource is a non-overlapping time resource of the at least one first time resource and the at least one second time resource.

In one aspect, when one of the type of channel and a type of signal is high priority,
the at least one third frequency resource is the at least one second frequency resource, and
the at least one third time resource is the at least one second time resource.

In one aspect, the high priority is one of
when the type of signal is a synchronization signal,
when the type of channel is one of broadcast channel, control channel, random access channel and a data channel comprising at least one system information, and
indicated by at least one second node in scheduling information.

In one aspect, the method further comprises performing, by at least one second node, one of transmission, reception and blanking in the at least one third frequency resource and the at least one third time resource.

In one aspect, performing blanking includes one of:
performing no transmission in the at least one third frequency resource and the at least one third time resource; and
indicating, by at least one second node, selected resources of the at least one third frequency resource and at least one time resource as a rate matching pattern and performing one of no transmission and no reception in the selected resources of the at least one third frequency resource and the at least one third time resource.

In one aspect, the method further comprises receiving at least one feedback by the at least one second node.

In one aspect, the at least one feedback is for one of transmission and reception in the a least one third frequency resource and the at least one third time resource.

In one aspect, the method further comprises transmitting, by the at least one second node a high priority indication with one of configuration information of at least one subband for SBFD operation and scheduling information.

In one aspect, the high priority indication allows the at least one first node to determine at least one third frequency resource and at least one third time resource.

In one aspect, one of the type of channel and the type of signal comprises at least one of:
reception of one or more of Physical Downlink Control Channel (PDCCH), Physical Downlink Shared Channel (PDSCH), and Channel Status Information-Reference Signal (CSI-RS); and
transmission of one or more of Physical Uplink Control Channel (PUCCH), Physical Uplink Shared Channel (PUSCH), Physical Random Access Channel (PRACH), and Sounding Reference Signal (SRS).

### BRIEF DESCRIPTION OF THE DRAWINGS

FIG. 1a illustrates non-overlapping subbands, FIG. 1b illustrates partially overlapping subbands, and FIG. 1c illustrates fully overlapping subbands.

FIG. 2 illustrates a notion of UL subband and SBFD active time resource.

FIG. 3 illustrates conflict among SBFD operation and conventional configurations.

FIG. 4 illustrates examples of collision occurring in SBFD scenario.

FIG. 5 illustrates skipping of PDSCH scheduled in resources overlapping with SBFD resources, in accordance with an embodiment of the present invention.

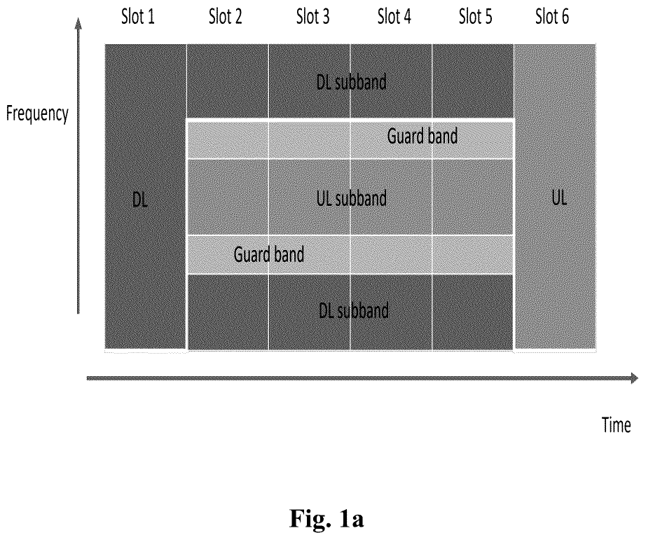

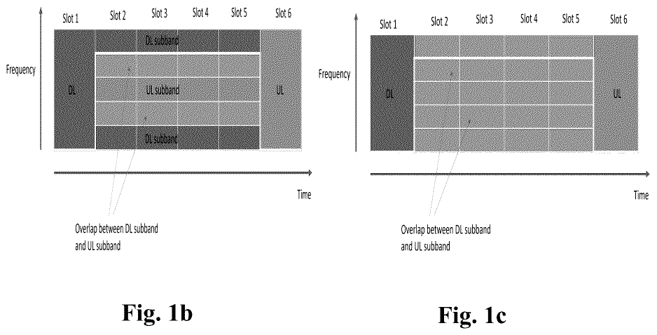

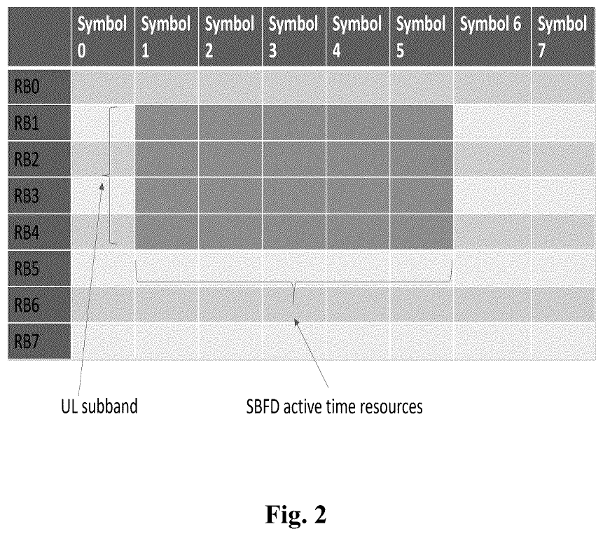

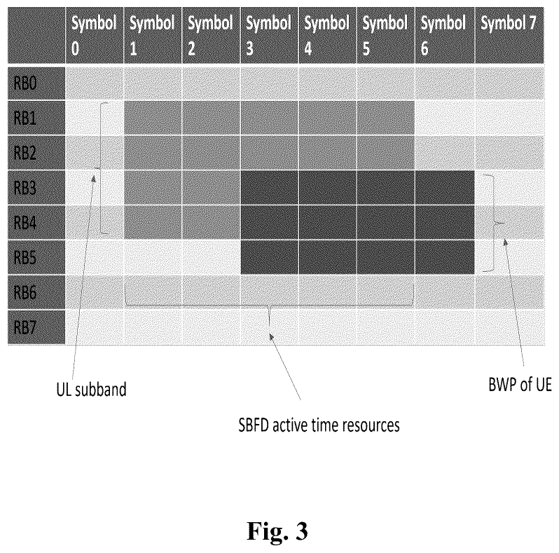

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Present invention describes various scenarios/conflicts arising due to enabling SBFD in a network and defines the behaviour of the nodes in response to various scenarios/conflicts. Further, present invention describes the impact of enabling SBFD on feedback mechanism defined in 5G-NR.

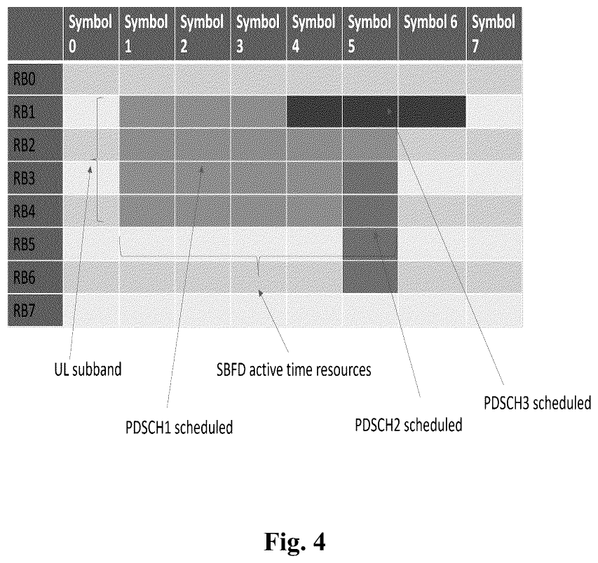

In one method, a gNB can indicate parameters of an SBFD operation (e.g., SBFD active symbols and subband) to a UE, such as a type 2 UE so that the UE can skip or adapt the configured operation accordingly. For example, in a scenario illustrated in FIG. 4, the gNB can indicate the RB1-RB5 as subband and symbol 1-symbol 5 as SBFD active time resource to the UE.

In one method, the UE receives the indication of the parameters from the gNB and skips the scheduled operation overlapping with the subband and SBFD active time resource. For example, in a scenario illustrated in FIG. 4, the UE completely skips PDSCH1, the UE receives PDSCH2 in RB5-RB6 and skips PDSCH2 reception in RB3-RB4, and the UE receive PDSCH3 in symbol 6 and skip PDSCH3 in symbol 4-5. For a set of symbols of a slot that are indicated to the UE as SBFD active time resource and for set of RBs indicated to the UE as UL subband, the UE does not receive DL control (physical downlink control channel i.e. PDCCH), PDSCH, or CSI-RS when the PDCCH, PDSCH, or CSI-RS in the set of symbols of the slot and in the set of RBs. For a set of symbols of a slot that are indicated to the UE as SBFD active time resource and for set of RBs indicated to the UE as DL subband, the UE does not transmit UL data (physical uplink shared channel i.e. PUSCH), UL control (physical uplink control channel, i.e. PUCCH), UL synchronization channel (physical random access channel i.e. PRACH), or UL reference signal (sounding reference signal i.e. SRS) in the set of symbols of the slot and in the set of RBs. The UE skipping the scheduled operation overlapping with the subband and the SBFD active time resource can be the UE's capability, and is reported to the gNB. Further, the UE skips the scheduled operation overlapping with the subband and the SBFD active time resource if enough switching gap is present between operations.

In another method, the UE receives an indication of the parameters from the gNB and skips the scheduled operation completely if at least one scheduled resource overlapping with the subband and SBFD active time resource. For example, as shown in FIG. 4, the UE skips all PDSCH1, PDSCH2, and PDSCH3, since the resources associated with them have at least a partial overlap with the SBFD resources. For a set of symbols of a slot that are indicated to the UE as SBFD active time resource and for set of RBs indicated to the UE as UL subband, the UE does not receive PDCCH, PDSCH, or CSI-RS when the PDCCH, PDSCH, or CSI-RS overlaps, even partially, with the set of symbols of the slot and the set of RBs. For a set of symbols of a slot indicated to the UE as SBFD active time resource and for set of RBs indicated to the UE as DL subband, the UE does not transmit PUSCH, PUCCH, PRACH, or SRS when the PUSCH, PUCCH, PRACH, or SRS overlaps, even partially, with the set of symbols of the slot and the set of RBs.

In another method, the UE skips/adapts the scheduled operation, based on indication of parameters of SBFD operation, only if the indication is received before certain time duration. For example, if the PDSCH is scheduled in symbols of slot n, then the UE will skip/adapt the PDSCH only if the parameters of SBFD is received at least by slot n−2. In case the scheduled operation is PUCCH/PUSCH, the time duration should be higher than the PUCCH/PUSCH preparation time.

If a UE is configured to transmit SRS, or PUCCH, or PUSCH, or PRACH in a set of symbols of a slot and the UE detects an indication about SBFD active time resource in a subset of symbols from the set of symbols, the UE does not expect to cancel the transmission in symbols from the set of symbols that occur, relative to a last symbol where the UE detects indication about SBFD active time resource, after a number of symbols that is smaller than the PUSCH preparation time for the corresponding UE processing capability. Alternatively, the UE cancels the PUCCH, or PUSCH, or PRACH transmission in remaining symbols from the set of symbols and cancels the SRS transmission in remaining symbols from the subset of symbols.

For a set of symbols of a slot corresponding to a valid PRACH occasion and Ngap symbols before the valid PRACH occasion, the UE does not expect the set of symbols of the slot to be indicated as SBFD active time resource.

In another method, the UE is not expected to receive any configuration conflicting with the SBFD configuration. For a set of symbols of a slot that are indicated to the UE as SBFD active time resource and for set of RBs indicated to the UE as UL subband, the UE does not expect to receive any parameter configuring reception from the UE in the set of symbols of the slot and in the set of RBs. For a set of symbols of a slot that are indicated to the UE as SBFD active time resource and for set of RBs indicated to the UE as DL subband, the UE does not expect to receive any parameter configuring transmission from the UE in the set of symbols of the slot and in the set of RBs.

Details are now provided for handling collision in case of high priority signals. The conflict resolution should consider various scenarios. The signals/channels configured to UE are of different priority. For example, signals/channels for DL synchronization signal (synchronisation signal block (SSB)/physical broadcast channel (PBCH)), UL synchronization (PRACH), providing basic system information (system information block, SIB) and providing basic control information (a.k.a. CORESET0 or PDCCH for Type0-PDCCH CSS) are high priority signals/channels for synchronization/initial attachment of a node to the network. Therefore, collision involving such signals should be handled separately compared to low priority signals like PDSCH. Following methods are proposed based on priority of signals/channels.

In one method, the gNB indicates priority level of the parameters of SBFD. The indication can be along with the parameters of SBFD. The priority level can be predefined along with the overriding rule. For example, indication of priority level 1 for the UL subband will override any DL scheduling at the UE whereas priority level 2 for the UL subband overrides all scheduling except SSB, SIB1 and CORESET0.

In another method, the set of high priority signals can be defined, and the UE performs transmission/reception of high priority signals even if the resources scheduled for high priority operation overlaps with SBFD resources. For example, SSB, SIB1, CORESET and PRACH are high priority signals and if scheduling of these signals overlaps with the scheduling of SBFD, then UE performs transmission/reception of high priority signals.

For a set of symbols of a slot indicated to the UE as SBFD active time resource and for the set of RBs indicated to the UE as UL subband, the UE transmits PUCCH, PUSCH, SRS or PRACH in the set of symbols and in the UL subband, if the UE does not detect any configuration for reception of SS/PBCH blocks or PDCCH for Type0-PDCCH CSS in at least one symbol of the set of symbols and at least one RB in the UL subband. Otherwise, the UE does not transmit PUCCH, PUSCH, SRS or PRACH in the set of symbols and in the UL subband.

For a set of symbols of a slot indicated to the UE as SBFD active time resource and for the set of RBs indicated to the UE as DL subband, the UE receives PDCCH, PDSCH, or CSI-RS in the set of symbols and in the DL subband, if the UE does not detect any configuration for transmission of PRACH in at least one symbol of the set of symbols and at least one RB in the DL subband. Otherwise, the UE does not receive PDCCH, PDSCH or CSI-RS in the set of symbols and in the DL subband.

In another method, the UE does not expect configuration for SBFD in symbols configured for high priority signals. For a set of symbols of a slot and set of RBs configured to the UE for transmission of SS/PBCH block or PDCCH for Type0-PDCCH CSS sets or for reception of a PRACH, the UE does not expect to receive any configuration for SBFD in the set of symbols of the slot and the set of RBs. For a set of symbols of a slot and set of RBs configured to the UE for transmission of SS/PBCH block or PDCCH for Type0-PDCCH CSS sets configured by pdcchConfigSIB1, the UE does not expect the set of symbols of the slot to be configured as SBFD active time resource and the set of RBs to be configured as UL subband for SBFD operation. For a set of symbols of a slot and set of RBs configured to the UE for reception of a PRACH, the UE does not expect the set of symbols of the slot to be configured as SBFD active time resource and the set of RBs to be configured as DL subband for SBFD operation.

Details are now provided for handling collision based on scheduling mechanism. The configuration of signals/channels to the UE can be done by higher layers or DCI. Similarly, the parameters of SBFD can be configured to the UE semi-statically or dynamically. The priority of signal/channel/parameter varies depending on mechanism of scheduling/configuring. For example, in 5G-NR specification, DCI overrides the PDCCH, PDSCH, DL positioning reference signal (PRS) and CSI-RS Rx configuration given by higher layers. Therefore, collision handling should consider scheduling mechanism of the colliding signal/channel and configuring mechanism of parameters of SBFD. Following methods are proposed in this regard.

In one method, the UE skips the transmission/reception of the operation configured by higher layer when the resources configured for operation overlaps with the SBFD resources. The operation can be transmission of PUCCH, PUSCH, SRS, PRACH and reception of PDCCH, PDSCH, DL PRS, CSI-RS.

If an SBFD aware UE is configured by higher layers to receive a PDCCH, or a PDSCH, or a CSI-RS, or a DL PRS in a set of symbols of a slot, the UE receives the PDCCH, the PDSCH, the CSI-RS, or the DL PRS if the UE does not detect an indication (semi-static and/or dynamic) to configure the at least one symbol of the set of symbols of the slot as SBFD active time resource. Otherwise, the UE does not receive the PDCCH, or the PDSCH, or the CSI-RS, or the DL PRS in the set of symbols of the slot.

If an SBFD aware UE is configured by higher layers to transmit a PUSCH, a PUCCH, a PRACH, or a SRS in a set of symbols of a slot, the UE transmits a PUSCH, a PUCCH, a PRACH, or a SRS if the UE does not detect an indication (semi-static and/or dynamic) to configure the at least one symbol of the set of symbols of the slot as SBFD active time resource. Otherwise, the UE does not receive the PDCCH, or the PDSCH, or the CSI-RS, or the DL PRS in the set of symbols of the slot

In another method, the operation configured by higher layers override the SBFD configuration and the UE perform transmission/reception of the operation configured by higher layer when the resources configured for operation overlaps with the SBFD resources. If an SBFD aware UE is configured by higher layers to receive a PDCCH, or a PDSCH, or a CSI-RS, or a DL PRS in a set of symbols of a slot and the UE detect an indication (semi-static and/or dynamic) to configure the at least one symbol of the set of symbols of the slot as SBFD active time resource, then the UE receives the PDCCH, the PDSCH, the CSI-RS, or the DL PRS. If an SBFD aware UE is configured by higher layers to transmit a PUSCH, a PUCCH, a PRACH, or a SRS in a set of symbols of a slot and the UE detect an indication (semi-static and/or dynamic) to configure the at least one symbol of the set of symbols of the slot as SBFD active time resource, then the UE receives the PDCCH, the PDSCH, the CSI-RS, or the DL PRS.

In one method, the UE skips the transmission/reception of the operation configured by DCI format when the resources configured for operation overlaps with the SBFD resources configured dynamically. The operation can be transmission of PUCCH, PUSCH, SRS, PRACH and reception of PDCCH, PDSCH, DL PRS, CSI-RS. If a UE is configured by DCI format to receive a PDCCH, or a PDSCH, or a CSI-RS, or a DL PRS in a set of symbols of a slot, the UE receives the PDCCH, the PDSCH, the CSI-RS, or the DL PRS if the UE does not detect a dynamic indication to configure the at least one symbol of the set of symbols of the slot as SBFD active time resource. Otherwise, the UE does not receive the PDCCH, or the PDSCH, or the CSI-RS, or the DL PRS in the set of symbols of the slot. If a UE is configured by DCI format to transmit a PUSCH, a PUCCH, a PRACH, or a SRS in a set of symbols of a slot, the UE transmit a PUSCH, a PUCCH, a PRACH, or a SRS if the UE does not detect a dynamic indication to configure the at least one symbol of the set of symbols of the slot as SBFD active time resource. Otherwise, the UE does not receive the PDCCH, or the PDSCH, or the CSI-RS, or the DL PRS in the set of symbols of the slot.

In another method, the UE performs the transmission/reception of the operation configured by DCI format even if the resources configured for operation overlaps with the SBFD resources. The operation can be transmission of PUCCH, PUSCH, SRS, PRACH and reception of PDCCH, PDSCH, DL PRS, CSI-RS. If a set of symbols of the slot is indicated as SBFD active time resource and a UE is configured by DCI format to receive a PDCCH, or a PDSCH, or a CSI-RS, or a DL PRS in at least one symbol of the set of symbols of a slot, then the UE receives the PDCCH, the PDSCH, the CSI-RS, or the DL PRS. If a set of symbols of the slot is indicated as SBFD active time resource and a UE is configured by DCI format to transmit a PUSCH, a PUCCH, a PRACH, or a SRS in at least one symbol of the set of symbols of a slot, then the UE transmits the PUSCH, a PUCCH, a PRACH, or a SRS.

In one method, the UE does not expect conflicting configurations from the gNB. For a set of symbols of a slot that are indicated to a UE as SBFD active time resources, the UE does not expect to receive both higher layer parameters or DCI format configuring transmission from the UE in the at least one symbol of the set of symbols of the slot and dedicated higher layer parameters or DCI format configuring reception by the UE in at least one symbol of the set of symbols of the slot.

Details are now provided to describe an impact of prioritization on feedback mechanism. Hybrid automatic repeat request (HARQ) refers to a re-transmission protocol in which the receiver checks for errors in the received data and if an error is detected then the receiver buffers the data and requests a re-transmission from the sender. A HARQ receiver is then able to combine the buffered data with the re-transmitted data prior to channel decoding and error detection. This improves the performance of the retransmissions. The HARQ codebook defines the format used to signal a set of HARQ acknowledgements to the gNB. The codebook allows the UE to multiplex the HARQ acknowledgements from multiple slots, multiple carriers, multiple Transport Blocks and multiple Code Block Groups (CBG) within a single transmission. Both the UE and the gNB should have the same understanding of the codebook format to ensure that each acknowledgement is linked to the appropriate transmission, which could be either signaled using RRC or defined in the standards specification.

In semi-static codebook, the UE sends feedback corresponding to all possible transmission opportunities within a time window. For example, the UE may be considered to be configured with a carrier that transfers a single Transport Block per transmission and a maximum of 4 Code Block Groups per Transport Block. If the UE is configured with 8 values for the ‘PDSCH-to-HARQ_feedback offset’ field for the carrier and with {Start Symbol and Length} combinations which allow 3 non-overlapping PDSCH transmissions per slot, then the codebook size is given by (1 carrier×4 CBG×8 offset×3 PDSCH per slot)=96 bits, i.e., there is an entry within the codebook for each potential HARQ acknowledgement. A benefit of the semi-static codebook is that it is robust against the UE failing to detect/decode a resource allocation on the PDCCH. All entries within the codebook for which the UE has not received a downlink resource allocation are populated with negative HARQ. However, the drawback of the semi-static codebook is that it has a fixed size.

The dynamic codebook helps to improve efficiency by excluding codebook entries which correspond to unused transmission opportunities. For example, the UE will include acknowledgement/negative acknowledgement (ACK/NACK) in the dynamic codebook corresponding to only those ‘PDSCH-to-HARQ_feedback offset’ for which the UE has received a PDCCH scheduling. If the UE is configured with 8 values for the ‘PDSCH-to-HARQ_feedback offset’ field for the carrier but received only 2 offset values in scheduling DCI, then UE will insert only 2 ACK/NACK in the dynamic codebook. This type of codebook poses a challenge in terms of maintaining the correct relationship between acknowledgement and transmission, especially when the UE fails to decode a DCI scheduling PDSCH. In the case of a dynamic codebook, if a UE misses a resource allocation on the PDCCH then the codebook size becomes smaller from the UE perspective and the gNB starts to map acknowledgements onto incorrect transmissions.

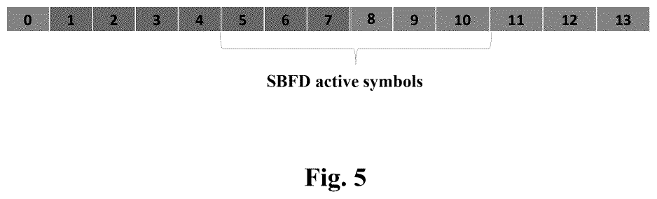

In case of UE skipping the scheduled operation in resources overlapping with the subband and/or SBFD active time resource, the feedback and retransmission mechanism need to be adapted accordingly. A scenario, as illustrated in FIG. 5 may be considered, where a PDSCH is scheduled for a UE in slot n from symbol 1 to 7. Further, the UE is indicated an UL subband overlapping with the active BWP and symbols 5 to 10 as SBFD active symbols. In that case, a conflict arises in symbols 5-7, where the UE is scheduled with PDSCH and UL subband.

In one method, the UE drops the PDSCH in all the symbols (SBFD and non-SBFD). Accordingly, the UE either sends no HARQ feedback for this PDSCH or sends a NACK.

In another method, the UE skips the operation scheduled in SBFD active resources, i.e., as shown in FIG. 5, the UE performs PDSCH reception in symbols 1-4 and skips the PDSCH scheduled in symbols 5-7. However, in the current HARQ feedback mechanism, the UE can send either ACK/NACK for the PDSCH scheduled within a slot. There is no provision to send feedback for partial reception or symbol level feedback. The following methods are proposed for such case.

In one method, if at least one symbol of a slot is configured for SBFD operation, then the UE will send feedback either for the SBFD active symbols or for the symbols in which SBFD is not active. For example, the type 1 UE sends feedback only for the SBFD active symbols, which are in candidate slots for HARQ feedback. Similarly, a type 2 UE sends feedback for the SBFD inactive symbols which are in candidate slot for HARQ.

In another method, the UE treats the SBFD resources as unscheduled and non-candidate resources for HARQ feedback. Therefore, UE can send feedback only for the resources which are not configured for SBFD operation. For example, in FIG. 5, the UE sends ACK for the slot when PDSCH scheduled in symbols 1-4 are decoded correctly, and NACK when PDSCH is not decoded correctly in symbols 1-4.

In another method, the UE performs the scheduled operation in SBFD active resources, i.e., in FIG. 5, the UE performs PDSCH reception in symbols 1-7 and reports HARQ accordingly. In such a case, the UL subband is rate matched around the PDSCH resources.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

We claim:

1. A method of handling collisions in a Sub Band Full Duplexing (SBFD) operation in a cellular network, the method comprising:
receiving, by at least one first node, at least one parameter from at least one second node, wherein the at least one parameter comprises at least one of configuration information of at least one subband for SBFD operation and scheduling information,
wherein the configuration information comprises at least one first time resource, at least one first frequency resource and an identity of the at least one subband,
wherein the at least one subband is active in the at least one first time resource and the at least one first frequency resource, and
wherein the scheduling information comprises at least one second time resource, at least one second frequency resource, and one of a type of channel and a type of signal;
determining, by the at least one first node, an overlap between
the at least one first time resource and the at least one second time resource, and
the at least one first frequency resource and the at least one second frequency resource;
determining, by the at least one first node, at least one third frequency resource and at least one third time resource based on the at least one parameter and the overlap; and
performing, one of transmission, reception and blanking in the at least one third frequency resource and the at least one third time resource.

2. The method as claimed in claim 1, wherein the type of signal is one of a DL signal and a UL signal.

3. The method as claimed in claim 1, wherein the type of channel is one of a DL channel and a UL channel.

4. The method as claimed in claim 1, wherein the type of channel is one of a broadcast channel, a control channel, and a data channel.

5. The method as claimed in claim 1, wherein the type of signal is one of a reference signal and a synchronization signal.

6. The method as claimed in claim 1, wherein when the identity of the at least one subband is same as one of the type of channel and the type of signal,
the at least one third frequency resource is an overlapping frequency resource of the at least one first frequency resource and the at least one second frequency resource, and
the at least one third time resource is an overlapping time resource of the at least one first time resource and the at least one second time resource.

7. The method as claimed in claim 1, wherein when the identity of the at least one subband is different from one of the type of channel and the type of signal,
the at least one third frequency resource is the at least one second frequency resource, and
the at least one third time resource is the at least one second time resource.

8. The method as claimed in claim 1, wherein when the identity of the at least one subband is different from one of the type of channel and the type of signal,
the at least one third frequency resource is a non-overlapping frequency resource of the at least one first frequency resource and the at least one second frequency resource, and
the at least one third time resource is a non-overlapping time resource of the at least one first time resource and the at least one second time resource.

9. The method as claimed in claim 1, comprising determining a time gap between receiving configuration information of at least one subband for SBFD operation and scheduling information is less than a threshold.

10. The method as claimed in claim 9, wherein the threshold is one of
a predefined value,
a value indicated by the at least one second node using at least one of RRC message, MAC-CE and DCI, and
a preparation time of at least one uplink signal.

11. The method as claimed in claim 1, wherein when one of the type of channel and the type of signal is high priority,
the at least one third frequency resource is the at least one second frequency resource, and
the at least one third time resource is the at least one second time resource.

12. The method as claimed in claim 11, wherein the high priority is one of
when the type of signal is a synchronization signal,
when the type of channel is one of broadcast channel, control channel, random access channel and a data channel comprising at least one system information, and
indicated by at least one second node in scheduling information.

13. The method as claimed in claim 1, wherein performing the blanking includes one of:
performing no transmission in the at least one third frequency resource and the at least one third time resource; and
performing no transmission in selected resources of the at least one third frequency resource and the at least one third time resource,
wherein the selected resources are indicated using a rate matching pattern from the at least one second node.

14. The method as claimed in claim 1, wherein one of the type of channel and the type of signal comprises at least one of:
reception of one or more of Physical Downlink Control Channel (PDCCH), Physical Downlink Shared Channel (PDSCH), and Channel Status Information-Reference Signal (CSI-RS); and
transmission of one or more of Physical Uplink Control Channel (PUCCH), Physical Uplink Shared Channel (PUSCH), Physical Random Access Channel (PRACH), and Sounding Reference Signal (SRS).

15. The method as claimed in claim 1, comprising transmitting at least one feedback by the at least one first node.

16. The method as claimed in claim 15, wherein the feedback is for one of transmission and reception in the at least one third frequency resource and the at least one third time resource.

17. The method as claimed in claim 15, wherein the feedback is for one of
an overlapping portion of the at least one first time resource and the at least one second time resource and an overlapping portion of the at least one first frequency resource and the at least one second frequency resource, and
at least one second time resource not overlapping with at least one first time resource and at least one second frequency resource not overlapping with at least one first frequency resource.

18. The method as claimed in claim 1, wherein determining the at least one third frequency resource and the at least one third time resource comprises:
determining whether the scheduling information is one of semi-static and dynamic; and
determining whether the configuration information is one of semi-static and dynamic.

19. A method of handling collisions in a Sub Band Full Duplexing (SBFD) operation in a cellular network, the method comprising:
transmitting, by at least one second node, at least one parameter to at least one first node, wherein the at least one parameter comprises at least one of configuration information of at least one subband for SBFD operation and scheduling information,
wherein the configuration information comprises at least one first time resource, at least one first frequency resource and an identity of the at least one subband,
wherein the at least one subband is active in the at least one first time resource and the at l east one first frequency resource, and
wherein the scheduling information comprises at least one second time resource, at least one second frequency resource, and one of a type of channel and a type of signal,
wherein transmission of the at least one parameter allows the at least one first node to:
determine an overlap between
the at least one first time resource and the at least one second time resource, and
the at least one first frequency resource and the at least one second frequency resource; and
determine at least one third frequency resource and at least one third time resource based on the at least one parameter and the overlap.

20. The method as claimed in claim 19, wherein the type of signal is one of a DL signal and a UL signal.

21. The method as claimed in claim 19, wherein the type of channel is one of DL channel and UL channel.

22. The method as claimed in claim 19, wherein the type of channel is at least one of a broadcast channel, a control channel, and a data channel.

23. The method as claimed in claim 19, wherein the type of signal is one of a reference signal and a synchronization signal.

24. The method as claimed in claim 19, wherein when the identity of the at least one subband is same as one of the type of channel and the type of signal,
the at least one third frequency resource is an overlapping frequency resource of the at least one first frequency resource and the at least one second frequency resource, and
the at least one third time resource is an overlapping time resource of the at least one first time resource and the at least one second time resource.

25. The method as claimed in claim 19, wherein when the identity of the at least one subband is different from one of the type of channel and the type of signal,
the at least one third frequency resource is the at least one second frequency resource, and
the at least one third time resource is the at least one second time resource.

26. The method as claimed in claim 19, wherein when the identity of the at least one subband is different from one of the type of channel and the type of signal,
the at least one third frequency resource is a non-overlapping frequency resource of the at least one first frequency resource and the at least one second frequency resource, and
the at least one third time resource is a non-overlapping time resource of the at least one first time resource and the at least one second time resource.

27. The method as claimed in claim 19, wherein when one of the type of channel and a type of signal is high priority,
the at least one third frequency resource is the at least one second frequency resource, and
the at least one third time resource is the at least one second time resource.

28. The method as claimed in claim 27, wherein the high priority is one of
when the type of signal is a synchronization signal,
when the type of channel is one of broadcast channel, control channel, random access channel and a data channel comprising at least one system information, and
indicated by at least one second node in scheduling information.

29. The method as claimed in claim 19, comprising performing, by at least one second node, one of transmission, reception and blanking in the at least one third frequency resource and the at least one third time resource.

30. The method as claimed in claim 29, wherein performing blanking includes one of:
performing no transmission in the at least one third frequency resource and the at least one third time resource; and
indicating, by at least one second node, selected resources of the at least one third frequency resource and at least one time resource as a rate matching pattern and performing one of no transmission and no reception in the selected resources of the at least one third frequency resource and the at least one third time resource.

31. The method as claimed in claim 19, comprising receiving at least one feedback by the at least one second node.

32. The method as claimed in claim 31, wherein the at least one feedback is for one of transmission and reception in the at least one third frequency resource and the at least one third time resource.

33. The method as claimed in claim 19, comprising transmitting, by the at least one second node a high priority indication with one of configuration information of at least one subband for SBFD operation and scheduling information.

34. The method as claimed in claim 33, wherein the high priority indication allows the at least one first node to determine at least one third frequency resource and at least one third time resource.

35. The method as claimed in claim 19, wherein one of the type of channel and the type of signal comprises at least one of:
reception of one or more of Physical Downlink Control Channel (PDCCH), Physical Downlink Shared Channel (PDSCH), and Channel Status Information-Reference Signal (CSI-RS); and
transmission of one or more of Physical Uplink Control Channel (PUCCH), Physical Uplink Shared Channel (PUSCH), Physical Random Access Channel (PRACH), and Sounding Reference Signal (SRS).
